(19) United States
(12) Patent Application Publication
(10) Pub. No.: US 2007/0278863 A1
(43) Pub. Date: Dec. 6, 2007

(54) Moving Magnet Type Linear Actuator

(75) Inventors: Masaya Yamamoto, Kitakyushu-shi (JP); Yasuhiro Miyamoto, Kitakyushu-shi (JP)

Correspondence Address: WESTERMAN, HATTORI, DANIELS & ADRIAN, LLP, 1250 CONNECTICUT AVENUE, NW, SUITE 700, WASHINGTON, DC, 20036, US

(73) Assignee: KABUSHIKI KAISHA YASKAWA DENKI, Kitakyushu-shi, Fukuoka (JP)

(21) Appl. No.: 10/582,944

(22) PCT Filed: Nov. 26, 2004
(86) PCT No.: PCT/JP04/17593

§ 371 Date: May 18, 2007

(30) Foreign Application Priority Data
Dec. 19, 2003 (JP) 2003-422134

(51) Int. Cl. H02K 41/02

(52) U.S. Cl. 310/12

(57) ABSTRACT

A moving magnet type linear actuator long in service life having no effect on a linear guide even in the case of performing a highly-frequent acceleration/deceleration operation is provided. In a moving magnet type linear actuator comprising a stator unit including a stator base, a magnetic core and an armature unit, and a moving unit including a field permanent magnet arranged so as to face the magnetic core via a magnetic first gap and a magnet holder of nonmagnetic material movably disposed on the stator base while holding the field permanent magnet, and a magnetic back yoke is arranged at an anti-armature side of the field permanent magnet via a magnetic second gap from the field permanent magnet, the magnetic second gap is set to be larger than the magnetic first gap.

### FIELD OF THE INVENTION

The present invention relates to a moving magnet type linear actuator equipped with a field magnet at a movable side. More specifically, it relates to a magnetic circuit structure for attaining weight saving of a movable unit.

### BACKGROUND OF THE INVENTION

In a moving coil type linear actuator, a structure in which a field permanent magnet and an armature are arranged via a magnetic gap is conventionally known. However, it was not easy to assuredly and safely supply electric power to the movable armature. To solve this problem, a linear actuator of a moving magnet type has been developed (see, e.g., Japanese Unexamined Laid-open Patent Publication No. 2001-352744 (JP '744)).

FIG. 5 is a figure showing a structure of the moving magnet type linear actuator disclosed in JP '744, wherein FIG. 5(a) is a plan view thereof, and FIG. 5(b) is a side sectional elevation thereof.

In FIG. 5, the reference numeral “60” denotes a moving magnet type linear actuator provided with a movable unit 20, a stator unit 30, a linear guide unit 40, and a position detecting unit 50.

The movable unit 20 is composed of a field permanent magnet 21, and a magnetic yoke 23 holding the field permanent magnet 21. The stator unit 30 is constituted mainly by a stator base 31, and an armature unit 32 secured to the stator base 31. The armature unit 32 is composed of a magnetic core 33, an armature winding 34 wound on the magnetic core 33, an insulating layer 35 surrounding the armature winding 34, and feeder cables 36 for supplying electric power to the armature winding 34.

The linear guide unit 40 (see FIG. 5(b)) is composed of linear guide rails 41, linear guide blocks 42 which run along the linear guide rails 41, and stopper mechanisms 43 (see FIG. 5(a)) which stop the movement of the linear guide block 42 at both ends of the traveling direction of the linear actuator 60.

The position detecting unit 50 is composed of a detecting unit supporter 51 secured to the stator base 31, a linear scale detecting unit 52 secured to the detecting unit supporter 51, a linear scale 53 secured to the movable unit via a proximal distance from the linear scale detecting unit 52, and signal lines 54.

At the back side of the field permanent magnet 21, a magnetic yoke 23 is disposed, so that both of them compose a magnetic circuit-cum-movable unit.

The armature unit 32 has a magnetic core with slots formed at equal pitches in which the armature winding 34 is wound. Thus, in this linear actuator 60, the movable unit can move within the stroke defined by the difference between the length of the armature unit and that of the field movable unit by applying electricity to the armature winding 34.

In the aforementioned device, however, since it was required to provide a field magnetic yoke 23 large in specific gravity at the side of the movable unit 20, there was a problem that acceleration performance of the movable unit 20 could not be improved.

Therefore, in order to sufficiently enhance the acceleration performance, the inventors considered it effective to detach a field magnetic yoke from a movable unit as described below.

That is, this moving magnet type linear actuator is composed of a stator base, a stator unit, and a movable unit. The stator unit consists of a magnetic core secured to the stator base and an armature winding wound around the magnetic core. The movable unit includes a field permanent magnet arranged so as to face the magnetic core via a magnetic gap and a magnet holder movably arranged on the stator base while supporting the field permanent magnet. In such actuator, the magnet holder is composed of nonmagnetic material, a magnetic back yoke is disposed at the anti-armature side of the field permanent magnet, and a gap is formed between the magnetic back yoke and the field permanent magnet.

In the aforementioned structure, since the magnet holder is made of nonmagnetic material, the weight saving of the moving unit can be attained. Furthermore, since the magnetic back yoke is disposed at the anti-armature side of the field permanent magnet, the portion formed by nonmagnetic material to attain the weight saving of the moving unit is compensated with the magnetic back yoke. Thus, it became possible to realize high thrust and high acceleration/deceleration, which in turn could attain maximum thrust and maximum acceleration/deceleration.

In such a linear motor, however, it turned out that the high-frequent acceleration/deceleration operation affects the life of the linear guide due to the strong magnetic attraction force acted between the movable unit side and the stator unit side.

The present invention was made to solve the aforementioned problems, and aims to provide a moving magnet type linear actuator long in service life having little or no effect on a linear guide even in the case of performing a highly-frequent acceleration/deceleration operation.

### SUMMARY OF THE INVENTION

The present invention was made to solve the aforementioned problems. According to one aspect of the present invention, a moving magnet type linear actuator includes a stator unit having a stator base and an armature unit having a magnetic core secured to the stator base and an armature winding wound around the magnetic core and a moving unit having a field permanent magnet arranged so as to face the magnetic core via a magnetic first gap and a magnet holder movably disposed on the stator base while holding the field permanent magnet.

The magnet holder is made of a nonmagnetic material, wherein a magnetic back yoke is arranged at an anti-armature side of the field permanent magnet, and has a width approximately the same as a width of the field permanent magnet and a length exceeding approximately a stroke of the moving unit and longitudinal ends of the magnetic back yoke are secured to the stator unit.

A magnetic second gap is formed between the magnetic back yoke and the field permanent magnet wherein the magnetic second gap is set to be larger than the magnetic first gap to offset magnetic attraction forces applied to the movable unit.

According to another aspect of the present invention, when the armature unit has an open slot, the magnetic first gap/the magnetic second gap is set to 0.45/0.55 to 0.35/0.65.

According to another aspect of the present invention, when the armature unit has a semi-open slot(s), the magnetic first gap/the magnetic second gap is set to 0.49/0.51 to 0.48/0.52.

According to another aspect of the present invention, a scale portion of a linear scale is secured to the magnet holder and a detecting portion of the linear scale is secured to the stator base so as to face the scale portion via a third gap.

According to another aspect of the present invention, two linear guide rails are extended in a longitudinal direction of the armature unit and arranged in parallel at both sides of the armature unit, wherein guide blocks are arranged on corresponding linear guide rails, and wherein the magnet holder is secured to the guide blocks.

According to another aspect of the present invention, a hole having a width corresponding to a width direction space between the guide blocks is formed in the magnet holder of nonmagnetic material, and the field magnet is secured in the hole.

According to another aspect of the present invention, a stopper mechanism is provided at each of four ends of the two parallel linear guide rails.

According to another aspect of the present invention, a conduit for forced cooling liquid medium is embedded in the stator base.

According to another aspect of the present invention, the magnetic back yoke is constituted by a laminated member of thin board electromagnetic plates.

As mentioned above, in the aforementioned moving magnet type linear actuator, the components of the movable side is made of nonmagnetic material and the field permanent magnet is embedded therein to thereby detach the field permanent magnet from the back yoke. Furthermore, the distance between the armature and the back yoke is adjusted. Thus, the attraction force applied to the movable unit can be offset to reduce the load to the guide, resulting in a long service life even if high acceleration/deceleration and high speed driving is performed.

### BRIEF DESCRIPTION OF THE DRAWINGS

A preferred embodiment of the present invention will be described with reference to the accompanying drawing wherein:

FIG. 1 shows a moving magnet type linear actuator according to one aspect of the present invention, wherein FIG. 1(a) is a plan view thereof and FIG. 1(b) is a sectional side elevation thereof;

FIG. 2 is a perspective view showing a principal portion of the linear actuator shown in FIG. 1;

FIG. 3 is an enlarged front cross-sectional view (taken along the stroke direction) of the moving magnet type linear actuator according to the present invention;

FIG. 4 is a diagram showing changes of the attraction force at the time of changing the magnetic gap in the moving magnet type linear actuator shown in FIG. 3, wherein FIG. 4(a) is a diagram showing the changes of the attraction force at the side of the armature winding and those at the side of the magnetic back yoke with respect to the misalignment from the center position, and FIG. 4(b) is a view defining two magnetic gaps; and

FIG. 5 shows a principle of a conventionally known moving magnet type linear actuator, wherein FIG. 5(a) is a plan view thereof and FIG. 5(b) is a sectional side elevation thereof.

### DETAILED DESCRIPTION OF THE INVENTION

Hereafter, the best mode for carrying out the present invention will be detailed.

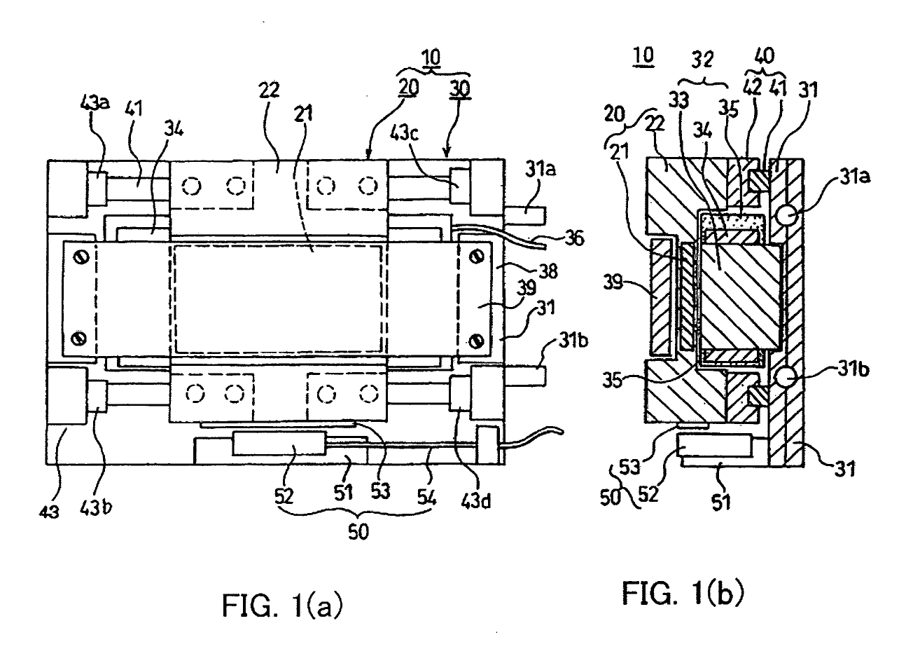

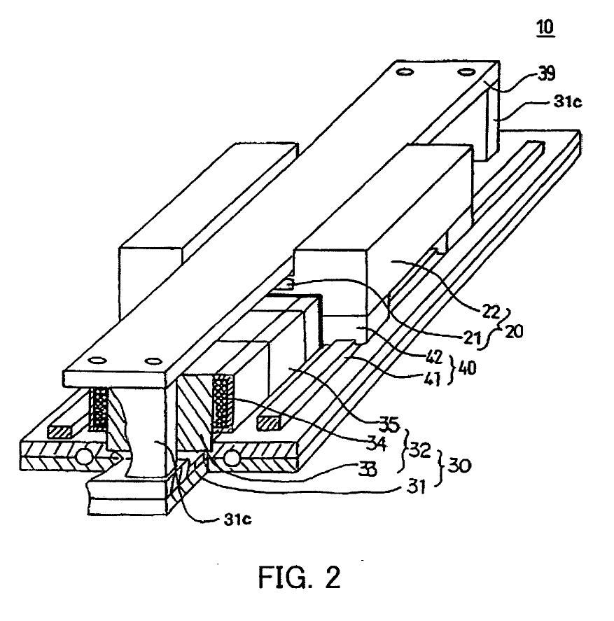

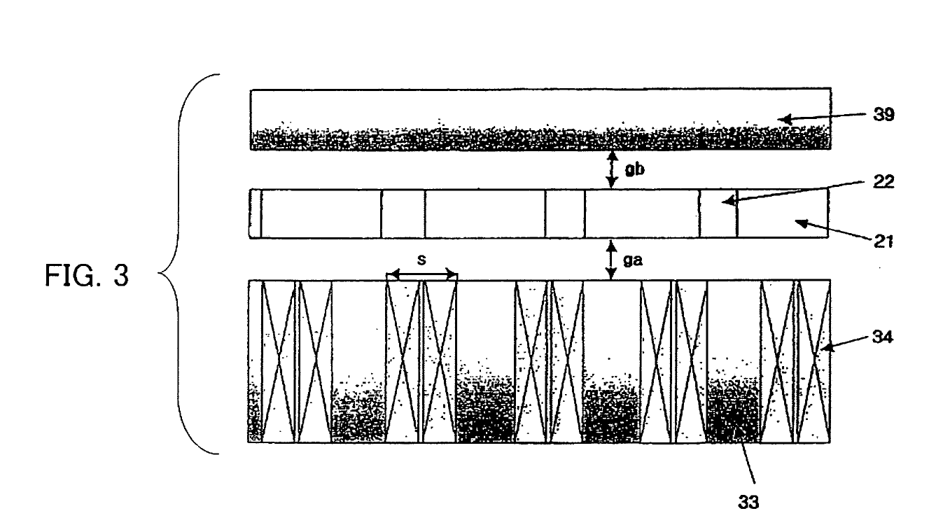

FIG. 1 shows a moving magnet type linear actuator, wherein FIG. 1(a) is the plan view thereof and FIG. 1(b) is the sectional side elevation thereof. FIG. 2 is a perspective view showing a principal portion of the linear actuator shown in FIG. 1.

In these figures, the reference numeral “10” denotes a moving magnet type linear actuator including a movable unit 20, a stator unit 30, a linear guide unit 40, and a position detecting unit 50, as components.

The movable unit 20 is composed of a field permanent magnet 21 and a nonmagnetic magnet holder 22 holding the field permanent magnet 21.

The stator unit 30 includes a stator base 31, an armature unit 32 secured to the stator base 31, and a magnetic back yoke 39. The armature unit 32 consists of a magnetic core 33, an armature winding 34 wound on the magnetic core 33, an insulating layer 35 surrounding the armature winding 34, and a feeder cables 36 for supplying electric power to the armature winding 34.

Thus, in this invention, the number of field magnetic poles is fewer than the number of magnetic poles of magnetomotive force produced in the armature unit 32. Therefore, this is a moving magnet type linear motor in which the difference of the number of magnetic poles causes a stroke of the linear actuator at the movable side.

Next, the structure of each part will be explained.

Initially, the structure of the movable unit 20 will be described. The field permanent magnets 21 each having the same width as the width of the magnetic core 33 are embedded in the plate-shaped magnet holder 22 of nonmagnetic material with the N pole and the S pole arranged alternatively along the traveling direction so as to face the magnetic core 33 of the stator unit 30 via a magnetic gap. Aluminum, which is light in weight, can be preferably used as the nonmagnetic material, and the field permanent magnet 21 is held by the holder with a gap formed between the magnet 21 and the magnetic core 33. The magnet holder 22 is secured to linear guide blocks 42 disposed on fore and aft portions of parallel two linear guide rails 41 arranged along the traveling direction of the holder 22. The portion of the magnet holder 22 for supporting the field permanent magnet 21 is formed to be as thin as possible and the magnetic back yoke 39 is arranged at the back side of the movable unit 20. This makes it possible to offset magnetic attraction forces and to allow a large gap flux density design, which in turn can attain high thrust and high acceleration/deceleration.

As explained above, the movable unit 20 having the field permanent magnet 21 is provided with guide blocks 42 coupled with the linear guide rails 41 at its right and left sides. The field permanent magnet 21 is secured in a hole or a dented portion the same in shape and size as the field magnet and formed in the nonmagnetic holder 22 between the guide blocks 42.

Furthermore, the movable unit 20 is provided with a scale portion 53 of the linear scale 50 with a gap (air gap) formed between the scale portion 53 and a detection portion 52 secured to the stator base 31.

Next, the structure of the stator unit 30 will be explained.

At the widthwise central portion of the stator base 31, a plurality of magnetic cores 33, each rectangular in cross-section, are arranged along the traveling direction of the movable unit 20 with the SN polarities alternatively arranged. An armature winding 34 is wound on each magnetic core 33 with the periphery covered with an insulating layer 35. Feeding of electric power to the armature winding 34 is performed by flexible electric cables 36 capable of moving by the maximum stroke length of the movable unit 20.

A magnetic back yoke 39 is arranged at the anti-armature side of the field permanent magnet 21 via a gap from the field permanent magnet 21. The magnetic back yoke 39 is extended in the traveling direction above the armature unit 32 with the magnetic back yoke 39 covering the armature unit 32 and the field permanent magnet 21, and secured to supporters 31c formed on the stator base 31. The magnetic back yoke 39 has a width almost the same as the width of the field permanent magnet 21 and a length exceeding the stroke of the moving unit 20. The magnetic back yoke 39 is preferably constituted by a laminated member of thin board electromagnetic plates.

Conduits 31a and 31b for forced cooling liquid medium are formed in the stator base 31. This conduit for forced cooling liquid medium 31a(31b) can be formed by fitting two plates having an elongated groove semicircular in cross-section with the grooves opposed each other to form a round cross-section. Thus, the conduits 31a for forced cooling liquid medium are formed in the stator base 31 to improve the effective thrust performance of the linear actuator 10 and to prevent temperature rise.

A linear guide unit 40 includes linear guide rails 41, linear guide blocks 42 which run on the linear guide rails 41, and a stopper mechanism 43 which forcibly stops the movement of the linear guide block 42 at both ends of the traveling direction of the linear actuator 10.

Thus, the stopper mechanism 43 is provided with shock absorbers 43a to 43d at four ends, i.e., the front, rear, right and left ends, of two parallel linear guide rails 41, serving an overrun prevention mechanism.

The position detecting unit 50 includes a detecting unit supporter 51 secured to the stator base 31, a linear scale detection portion 52 secured to the detecting unit supporter 51, and a linear scale portion 53 secured to the movable unit side in proximity distance from the linear scale detection portion 52.

As explained above, in the moving magnet type linear actuator, since the magnet holder is made of nonmagnetic material, weight saving of the moving unit can be attained.

Furthermore, since the magnetic back yoke is disposed at the anti-armature side of the field permanent magnet, the portion formed by nonmagnetic material to attain the weight saving of the moving unit is compensated with the magnetic back yoke, which in turn could attain maximum thrust and maximum acceleration/deceleration.

Furthermore, since the magnetic back yoke has a width approximately the same as that of the field permanent magnet and a length exceeding the stroke of the moving unit, both longitudinal ends are secured to the securing portions, and a gap is formed between the magnetic back yoke and a field permanent magnet, it becomes possible to realize possible maximum thrust and possible maximum acceleration/deceleration.

Furthermore, since the scale portion of the linear scale is secured to the magnet holder, the detecting portion of the linear scale is secured to the stator base 31 via a gap from the scale portion and the magnet holder is made of nonmagnetic material, the position detecting unit is hardly affected by magnetic field lines.

In such a linear motor, however, as previously mentioned, the high-frequent acceleration/deceleration operation affects the life of the linear guide due to the strong magnetic attraction force acted between the movable unit side and the stator side.

Then, the relation of two magnetic gaps was searched.

The magnetic gap (magnetic second gap) between the back yoke and the field permanent magnet which offset magnetic attraction force was calculated by the following equations (1) and (2) since the armature unit has a core.

FIG. 3 is an enlarged front cross-sectional view (taken along the stroke direction) of the moving magnet type linear actuator according to the present invention. In FIG. 3, the reference numeral “21” denotes the field permanent magnet, “22” denotes the nonmagnetic magnet holder, “33” denotes the magnetic core, “34” denotes the armature winding, and “39” denotes the magnetic back yoke.

In the below-mentioned formula, “ga” denotes a magnetic gap (magnetic first gap) between the armature winding and the field permanent magnet, and “s” denotes a slot opening width.

At the time of calculating the flux density between the armature winding with teeth and the field permanent magnet, considering Carter's coefficient (Kc), the weakened flux density (Equivalent magnetic gap length of the magnetic first gap to the magnetic second gap since the flux density generated in a magnetic gap is weaker than that of the permanent magnet facing the magnetic back yoke because the field permanent magnet faces the slots) is calculated by the following equations to make the flax density between <the field permanent magnet and the armature unit>, and the flax density between <the field permanent magnet and the magnetic back yoke> equal.
Kc=slot pitch/<slot pitch−β·ga) (1)
β=(s/ga)²/{5+(s/ga)}
Magnetic second gap(gb)=magnetic first gap (ga)×Kc (2)

where, Kc: Carter's coefficient, ga: magnetic gap length, s: slot opening width

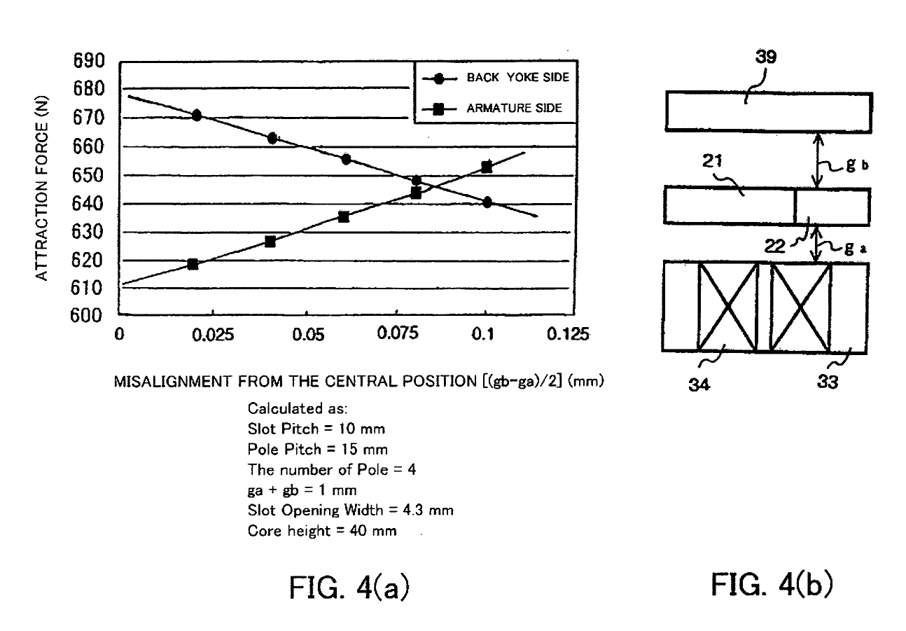

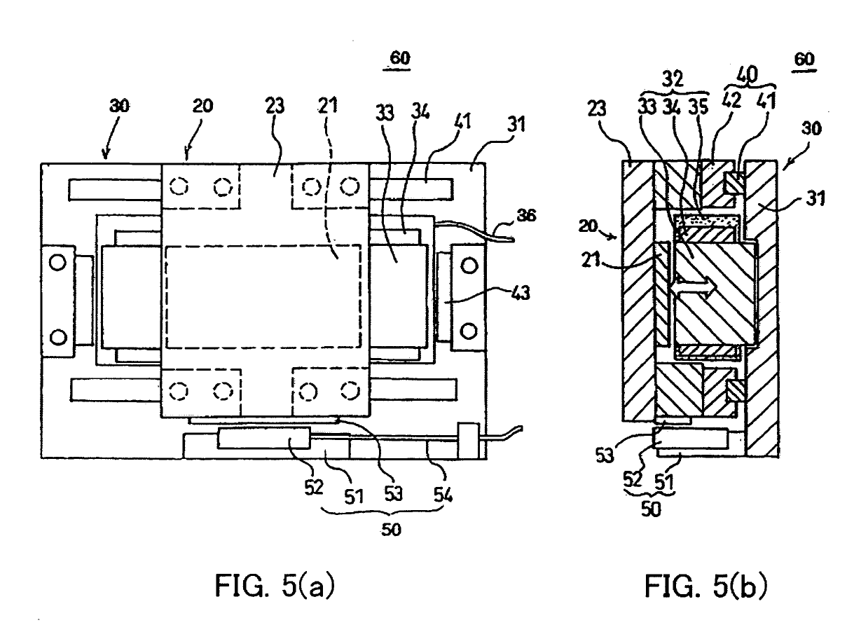

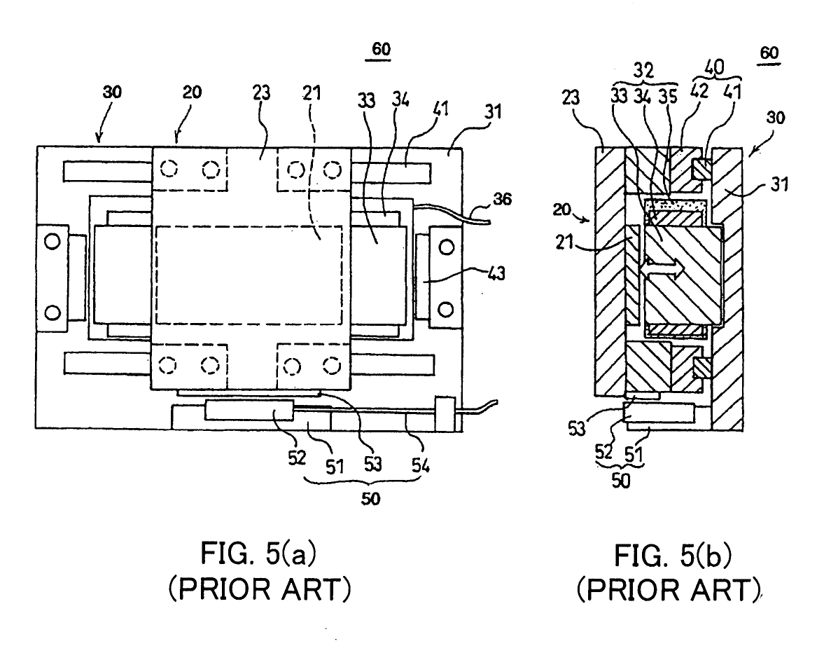

FIG. 4 is a diagram showing changes of the attraction force at the time of changing the magnetic gap in the moving magnet type linear actuator shown in FIG. 3, wherein FIG. 4(a) is a diagram showing the changes of the attraction force at the side of the armature winding and those at the side of the magnetic back yoke with respect to the misalignment from the center position, and FIG. 4(b) is a view defining two magnetic gaps, ga and gb. “ga” denotes the length (magnetic first gap) of the gap between the field permanent magnet 21 and the armature winding 34, and “gb” denotes the length (magnetic second gap) of the gap between the field permanent magnet 21 and the magnetic back yoke 39.

In FIG. 4, the attraction force is calculated under the conditions of the slot pitch: 10 mm, the pole pitch: 15 mm, the number of poles: 4, ga+gb=1 mm, slot opening width: 4.3 mm, and core height: 40 mm.

Attraction forces N were obtained by performing numerical computation by, for example, magnetic field analysis simulation.

In FIG. 4(a), when the field permanent magnet 21 is located at the center (ga=gb) between the armature winding 12 and the magnetic back yoke 10, the attraction force at the side of the back yoke was maximum (680 N), and the attraction force at the side of the armature was minimum (610 N).

When the misalignment from the center position was 0.10 mm, the attraction force at the side of the back yoke was 640 N and the attraction force at the side of the armature was 655 N. The attraction forces were reversed. Then, when the position where both attraction forces become equal is obtained, both the attraction forces became 646 N at the position where the misalignment from the center position was 0.085 mm.

According to the present invention, when the field permanent magnet 21 is arranged at the position misaligned from the center position where both the attraction forces becomes equal, no attraction force acts on the movable unit side or the stator unit side. Therefore, influence on the linear guide can be eliminated even if highly-frequent acceleration/deceleration operation is performed, resulting in a long service life.

In the case where the slot of the armature unit is a typical open slot, it is preferably set that the first gap/the second gap =0.45/0.55 to 0.35/0.65. In cases where it is far from the current linear motor in structure, the dimension may fall outside the aforementioned range.

In the case where the slot of the armature unit is a semi-open slot, and if it is a semi open slot with a small opening width, it is preferable to set the first gap/the second gap=0.49/0.51 to 0.48/0.52.

As mentioned above, according to the present invention, since no attraction force acts on the movable unit side or the stator unit side, even if a highly-frequent acceleration/deceleration operation is performed, influence on a linear guide can be eliminated, resulting in a long service life.

As mentioned above, in the present invention, the attraction forces applied to the movable unit can be offset, and the load to the guide can be decreased, resulting in a long service life of the guide even if a high thrust, high acceleration/deceleration, and high speed operation is performed. Therefore, it can be preferably applied to a linear motion stage apparatus which is required to perform precise positioning, and various semiconductor fabrication apparatuses, machine tools, etc., requiring such a linear motion stage apparatus.

We claim:

1. A moving magnet type linear actuator, comprising:
a stator unit including a stator base and an armature unit having a magnetic core secured to the stator base and an armature winding wound around the magnetic core; and
a moving unit including a field permanent magnet arranged so as to face the magnetic core via a magnetic first gap and a magnet holder movably disposed on the stator base while holding the field permanent magnet,
wherein the magnet holder is made of nonmagnetic material,
wherein a magnetic back yoke is arranged at an anti-armature side of the field permanent magnet, and has a width approximately the same as a width of the field permanent magnet and a length exceeding approximately a stroke of the moving unit, longitudinal ends of the magnetic back yoke being secured to the stator unit,
wherein a magnetic second gap is formed between the magnetic back yoke and the field permanent magnet, and
wherein the magnetic second gap is set to be larger than the magnetic first gap to offset magnetic attraction forces applied to the movable unit.

2. The moving magnet type linear actuator as recited in claim 1, wherein, when the armature unit has an open slot, the magnetic first gap/the magnetic second gap is set to 0.45/0.55 to 0.35/0.65.

3. The moving magnet type linear actuator as recited in claim 1, wherein, when the armature unit has a semi-open slot, the magnetic first gap/the magnetic second gap is set to 0.49/0.51 to 0.48/0.52.

4. The moving magnet type linear actuator as recited in claim 1, wherein a scale portion of a linear scale is secured to the magnet holder, and wherein a detecting portion of the linear scale is secured to the stator base so as to face the scale portion via a third gap.

5. The moving magnet type linear actuator as recited in claim 2 or 3, wherein two linear guide rails are extended in a longitudinal direction of the armature unit and arranged in parallel at both sides of the armature unit, wherein guide blocks are arranged on corresponding linear guide rails, and wherein the magnet holder is secured to the guide blocks.

6. The moving magnet type linear actuator as recited in claim 5, wherein a hole having a width corresponding to a width direction space between the guide blocks is formed in the magnet holder of nonmagnetic material, and the field magnet is secured in the hole.

7. The moving magnet type linear actuator as recited in claim 5, wherein a stopper mechanism is provided at each of four ends of the two parallel linear guide rails.

8. The moving magnet type linear actuator as recited in claim 1 or 4, a conduit for forced cooling liquid medium is embedded in the stator base.

9. The moving magnet type linear actuator as recited in claim 1, wherein the magnetic back yoke is constituted by a laminated member of thin board electromagnetic plates.
